(19) United States
(12) Patent Application Publication
(10) Pub. No.: US 2025/0246644 A1
(43) Pub. Date: Jul. 31, 2025

(54) FUEL CELL

(71) Applicant: TOYOTA JIDOSHA KABUSHIKI KAISHA, Toyota-shi (JP)

(72) Inventors: Hiroaki TAKEUCHI, Susono-shi (JP); Takenori KOYANAGI, Susono-shi (JP); Yusuke OTSU, Shizuoka-ken (JP); Joji AOCHI, Gotemba-shi (JP)

(21) Appl. No.: 19/036,114

(22) Filed: Jan. 24, 2025

(30) Foreign Application Priority Data
Jan. 30, 2024 (JP) 2024-011722

(51) Int. Cl. H01M 8/026; H01M 8/0247

(52) U.S. Cl. CPC H01M 8/026; H01M 8/0247

(57) ABSTRACT

To provide a fuel cell capable of suppressing deterioration in power generation performance. A fuel cell, wherein the fuel cell comprises at least a power generation unit and a pair of separators sandwiching the power generation unit; wherein each of the pair of separators has a groove constituting a flow path; wherein the power generation unit comprises a gas diffusion layer; and wherein, in a region of the power generation unit, a surface pressure on an upstream side of an oxidant gas flow direction is larger than a surface pressure on a downstream side of the oxidant gas flow direction.

### TECHNICAL FIELD

The disclosure relates to a fuel cell.

### BACKGROUND

Various studies have been proposed for fuel cells (FC) as disclosed in Patent Documents 1 and 2.

Patent Document 1: Japanese Patent Application Laid-Open (JP-A) No. 2008-171598

Patent Document 2: Japanese Patent Application Laid-Open (JP-A) No. 2006-147501

Patent Document 1 discloses a technique for equalizing the surface pressure distribution of a fuel cell. On the downstream side of an oxidant gas flow direction in the fuel cell, a gas diffusion resistance is more dominant than an electric resistance. Therefore, if the surface pressure of the fuel cell is too high, the gas diffusion resistance increases, and the power generation performance of the fuel cell may deteriorate.

### SUMMARY

The disclosure was achieved in light of the above circumstances. An object of the disclosure is to provide a fuel cell configured to suppress a deterioration in power generation performance.

That is, the present disclosure includes the following embodiments.

<1> A fuel cell,
wherein the fuel cell comprises at least a power generation unit and a pair of separators sandwiching the power generation unit;
wherein each of the pair of separators has a groove constituting a flow path;
wherein the power generation unit comprises a gas diffusion layer; and
wherein, in a region of the power generation unit, a surface pressure on an upstream side of an oxidant gas flow direction is larger than a surface pressure on a downstream side of the oxidant gas flow direction.

<2> The fuel cell according to <1>,
wherein in a condition in which the gas diffusion layer is not pressurized, a thickness of the gas diffusion layer on the upstream side of the oxidant gas flow direction is larger than a thickness of the gas diffusion layer on the downstream side of the oxidant gas flow direction.

<3> The fuel cell according to <1> or <2>,
wherein a density of the gas diffusion layer on the upstream side of the oxidant gas flow direction is larger than a density of the gas diffusion layer on the downstream side of the oxidant gas flow direction.

<4> The fuel cell according to any one of <1> to <3>,
wherein a depth of the groove on the upstream side of the oxidant gas flow direction is larger than a depth of the groove on the downstream side of the oxidant gas flow direction.

<5> The fuel cell according to any one of <1> to <4>,
wherein one of the pair of separators is a cathode separator, and the other is an anode separator;
wherein the cathode separator has the groove constituting the oxidant gas flow path; and
wherein, when an entire region of the oxidant gas flow path is regarded as 100%, the upstream side of the oxidant gas flow direction is a region which is 30% to 70% of the entire region on the oxidant gas inlet side of the oxidant gas flow path.

The fuel cell of the present disclosure is configured to suppress a deterioration in power generation performance.

### BRIEF DESCRIPTION OF THE DRAWINGS

In the accompanying drawings,

FIG. 1 is a schematic view showing an example of the cathode separator of the fuel cell of the present disclosure when viewed in plan;

FIG. 2 is a schematic view showing another example of the cathode separator of the fuel cell of the present disclosure when viewed in plan; and

FIG. 3 is a schematic view showing another example of the cathode separator of the fuel cell of the present disclosure when viewed in plan.

### DETAILED DESCRIPTION

Hereinafter, the embodiments of the present disclosure will be described in detail. Matters that are required to implement the present disclosure (such as common a fuel cell structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In addition, dimensional relationships (length, width, thickness, and the like) in the drawings do not reflect actual dimensional relationships.

In the present disclosure, a gas supplied to the anode of the fuel cell is a fuel gas (anode gas), and the gas supplied to the cathode of the fuel cell is an oxidant gas (cathode gas). The fuel gas is a gas mainly containing hydrogen, and may be hydrogen. The oxidant gas is a gas containing oxygen, and may be oxygen, air, or the like. In the present disclosure, the fuel gas and the oxidizing gas are collectively referred to as a reaction gas or a gas.

In the present disclosure, there is provided a fuel cell, wherein the fuel cell comprises at least a power generation unit and a pair of separators sandwiching the power generation unit;
wherein each of the pair of separators has a groove constituting a flow path;
wherein the power generation unit comprises a gas diffusion layer; and
wherein, in a region of the power generation unit, a surface pressure on an upstream side of an oxidant gas flow direction is larger than a surface pressure on a downstream side of the oxidant gas flow direction.

The present disclosure provides a measures of surface pressure distribution for improving the power generation performance of a fuel cell. In the related art, in the power generation unit of the battery, the power generation performance of the fuel cell is improved by applying as uniform a surface pressure as possible and lowering the electric resistance of the fuel cell at a surface pressure equal to or higher than a predetermined value. However, depending on the portion of the power generation unit, there are regions in which the surface pressure is higher and regions in which the surface pressure is lower, so that optimum power generation performance cannot be obtained. On the downstream side of the fuel cell in the oxidant gas flow direction, the gas diffusion resistance is more dominant than the electric resistance, and therefore, when the surface pressure is high, the gas diffusion layer collapses, so that the gas diffusion resistance is increased and the power generation performance of the fuel cell is lowered.

In the present disclosure, as the surface pressure distribution in the oxidant gas flow direction, the flow direction upstream side>the flow direction downstream side is set so that the reduction of the electric resistance is prioritized on the flow direction upstream side, and the reduction of the gas diffusion resistance is prioritized on the flow direction downstream side, so that an appropriate power generation state is set. The surface pressure distribution is controlled by setting the distribution of the thickness of the gas diffusion layer, the density of the gas diffusion layer, or the height of the flow path as a realization structure.

For various applications such as vehicles, when operating while suppressing the auxiliary power of the air compressor or the like to, for example, an air stoichiometric ratio of 2 or less, the concentration overvoltage is likely to be generated due to the oxygen partial pressure drop at about ⅓ of the flow direction downstream side of the oxidant gas flow path.

In a fuel cell of a proton conduction type, since protons and oxygen meet at the cathode side to generate electricity, oxygen needs to be transferred to the catalyst surface in the presence of generated moisture. Therefore, the surface pressure design of the present disclosure is suitable for a proton conduction type fuel cell in which gas diffusion on the cathode side is likely to be a problem.

In a fuel cell of a type in which a product is generated on the anode side, in a fuel cell in which a gas diffusion layer having surface pressure dependency is used, a surface pressure design similar to that on the cathode side may be made based on the flow direction of the anode gas.

The flow path type is more suitable for a groove flow path type in which the lower side of the rib is more susceptible to gas diffusion than for a porous body flow path in which the gas supply is more uniform. The groove channel type may be a non- throttled groove channel or a throttled groove channel.

The fuel cell of the present disclosure may be mounted on a moving body such as a vehicle, or may be mounted on a vehicle. Further, the fuel cell of the present disclosure may be mounted in a stationary power generation system such as a generator and used.

The vehicle may be a fuel cell vehicle or the like. Examples of the moving body other than the vehicle include a railway, a ship, and an aircraft.

Further, the fuel cell of the present disclosure may be mounted on a moving body such as a vehicle capable of traveling even with electric power of a secondary battery.

The mobile body and the stationary power generation system may include the fuel cell of the present disclosure. The moving body may include a drive unit such as a motor, an inverter, and a hybrid control system.

The hybrid control system may be capable of driving a moving body by using both the output of the fuel cell and the electric power of the secondary battery.

The fuel cell may have only one unit cell, or may be a fuel cell stack in which a plurality of unit cells are stacked.

In the present disclosure, both the unit cell and the fuel cell stack may be referred to as a fuel cell.

The number of stacked unit cells in the fuel cell stack is not particularly limited, and may be, for example, 2 to several hundred.

The unit cell of the fuel cell includes at least a power generation unit and a pair of separators sandwiching the power generation unit.

The shape of the power generation unit may be a rectangular shape in a plan view.

The power generation unit includes at least a gas diffusion layer.

The power generation unit may include a membrane electrode assembly (MEA) including an electrolyte membrane and two electrodes sandwiching the electrolyte membrane.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The two electrodes are one anode (fuel electrode) and the other cathode (oxidant electrode).

The electrode includes a catalyst layer and may optionally include a gas diffusion layer. The power generation unit may be a membrane electrode gas-diffusion-layer assembly (MEGA). In this case, the unit cell may include a cathode separator, an anode separator, and a membrane electrode gas diffusion layer assembly disposed between the cathode separator and the anode separator.

The membrane electrode gas diffusion layer assembly includes an anode-side gas diffusion layer, an anode catalyst layer, an electrolyte membrane, a cathode catalyst layer, and a cathode-side gas diffusion layer in this order.

The anode catalyst layer and the cathode catalyst layer are collectively referred to as a catalyst layer.

The anode-side gas diffusion layer and the cathode-side gas diffusion layer are collectively referred to as a gas diffusion layer.

The catalyst layer may include a catalyst, and the catalyst may include a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used. The catalyst metal used as the cathode catalyst and the catalyst metal used as the anode catalyst may be the same or different.

The electrolyte may be a fluorine-based resin or the like. As the fluorine-based resin, for example, a Nafion solution or the like may be used.

The catalyst metal may be supported on a support, and in each of the catalyst layers, a support (catalyst-supported support) on which the catalyst metal is supported and an electrolyte may be mixed.

Examples of the support for supporting the catalyst metal include carbon materials such as carbon, which are generally commercially available.

The gas-diffusion layer (GDL) may comprise a substrate and a mesoporous layer (MPL).

GDL may include a base material on a side in contact with the separator and a MPL on a side in contact with the catalytic layer.

The base material may be a conductive member or the like having gas permeability.

Examples of the base material include a carbon porous body such as carbon cloth and carbon paper, and a metal porous body such as a metal mesh and a metal foam.

MPL may include a mixture of a water-repellent resin such as PTFE and a conductive material such as carbon black.

MPL may include an antioxidant such as Ce. The generation of radicals can be prevented by an antioxidant.

The unit cell may include an insulating resin frame disposed on the outer side (outer periphery) in the surface direction of the membrane electrode assembly between the anode separator and the cathode separator. The resin frame is formed to have a plate shape and a frame shape by using a thermoplastic resin, and seals between the anode separator and the cathode separator in a condition where the membrane electrode assembly is held in a central region thereof. As the resin frame, for example, resins such as PE, PP, PET, and PEN can be used. The resin frame may be a three-layer sheet composed of three layers in which an adhesive layer is disposed on a surface layer.

The fuel cell stack may include a gasket, a resin sheet, and the like between the unit cells to seal each gas. The resin sheet may be the resin frame described above.

The separator collects current generated by power generation and functions as a partition wall. The separator is disposed on both sides in the stacking direction of the power generation unit such that the pair of separators sandwich the power generation unit in the unit cell. One of the pair of separators is an anode separator and the other is a cathode separator. The anode separator and the cathode separator are collectively referred to as a separator.

The pair of separators has a groove that forms a flow path.

The anode separator may have a groove forming a fuel gas flow path on a surface of the power generation unit side.

The cathode separator may have a groove forming an oxidant gas flow path on a surface of the power generation unit side.

The separator may have holes constituting a manifold such as a supply hole and a discharge hole for allowing a fluid such as a reaction gas and a refrigerant to flow in the stacking direction of the unit cells.

Examples of the refrigerant include water, a mixed solvent of water and ethylene glycol, and the like.

The separator may be, for example, dense carbon obtained by compressing carbon to make it impermeable to gas, and press-formed metal (for example, iron, titanium, stainless steel, and the like).

In the region of the power generation unit of the fuel cell, the surface pressure on the upstream side in the oxidant gas flow direction is larger than the surface pressure on the downstream side in the oxidant gas flow direction.

From the viewpoint of providing the surface pressure distribution in the region of the power generation unit of the fuel cell, in a condition in which the gas diffusion layer is not pressurized, the thickness of the gas diffusion layer on the upstream side in the oxidant gas flow direction may be larger than the thickness of the gas diffusion layer on the downstream side in the oxidant gas flow direction. In a condition in which the gas diffusion layer is not pressurized, the thickness of at least one of the anode-side gas diffusion layer on the upstream side in the oxidant gas flow direction and the cathode-side gas diffusion layer may be larger than the thickness of the gas diffusion layer on the downstream side in the oxidant gas flow direction. In a condition in which the gas diffusion layer is not pressurized, the thickness of the cathode-side gas diffusion layer on the upstream side in the oxidant gas flow direction may be larger than the thickness of the cathode-side gas diffusion layer on the downstream side in the oxidant gas flow direction. In a condition in which the gas diffusion layer is not pressurized, the thickness of the anode-side gas diffusion layer on the upstream side in the oxidant gas flow direction may be larger than the thickness of the anode-side gas diffusion layer on the downstream side in the f oxidant gas flow direction.

In a condition in which the gas diffusion layer is pressurized, the thickness of the gas diffusion layer on the upstream side in the oxidant gas flow direction may be the same as the thickness of the gas diffusion layer on the downstream side in the oxidant gas flow direction.

From the viewpoint of providing the surface pressure distribution in the region of the power generation unit of the fuel cell, the density of the gas diffusion layer on the upstream side in the oxidant gas flow direction may be larger than the density of the gas diffusion layer on the downstream side in the oxidant gas flow direction. The density of the gas diffusion layer of at least one of the anode-side gas diffusion layer and the cathode-side gas diffusion layer on the upstream side in the oxidant gas flow direction may be larger than the density of the gas diffusion layer on the downstream side in the oxidant gas flow direction. The density of the cathode-side gas diffusion layer on the upstream side in the oxidant gas flow direction may be larger than the density of the cathode-side gas diffusion layer on the downstream side in the oxidant gas flow direction. The density of the anode-side gas diffusion layer on the upstream side in the oxidant gas flow direction may be larger than the density of the anode-side gas diffusion layer on the downstream side in the oxidant gas flow direction.

The material of the gas diffusion layer on the upstream side in the oxidant gas flow direction may be different from or the same as the material of the gas diffusion layer on the downstream side in the oxidant gas flow direction.

The flow direction of the fuel gas may be the same as the oxidant gas flow direction, or may be a counter flow.

From the viewpoint of providing the surface pressure distribution in the region of the power generation unit of the fuel cell, the depth of the groove of the separator on the upstream side in the oxidant gas flow direction may be larger than the depth of the groove of the separator on the downstream side in the oxidant gas flow direction. The depth of the groove of at least one of the anode separator on the upstream side in the oxidant gas flow direction and the cathode separator may be larger than the depth of the groove of the separator on the downstream side in the oxidant gas flow direction. The depth of the groove of the cathode separator on the upstream side in the oxidant gas flow direction may be larger than the depth of the groove of the cathode separator on the downstream side in the oxidant gas flow direction. The depth of the groove of the anode separator on the upstream side in the oxidant gas flow direction may be larger than the depth of the groove of the anode separator on the downstream side in the oxidant gas flow direction.

In the present disclosure, the upstream side in the oxidant gas flow direction may be a region of 30% to 70% from the oxidant gas inlet side of the oxidant gas flow path, a region of 50% to 70%, or a region of 70% when the entire area of the oxidant gas flow path is 100%.

In the present disclosure, the flow direction downstream side of the oxidant gas may be a region of 30% to 70% from the oxidant gas outlet side of the oxidant gas flow path, a region of 30% to 50%, or a region of 30% when the entire area of the oxidant gas flow path is 100%.

The surface pressure distribution may be designed according to the operating conditions of the fuel cell, the specifications of the flow path of the separators, the specifications of MEGA, and the like.

For example, the surface pressure in the region of 70% from the oxidant gas inlet side of the oxidant gas flow path may be higher than the surface pressure in the region of 30% from the oxidant gas outlet side of the oxidant gas flow path.

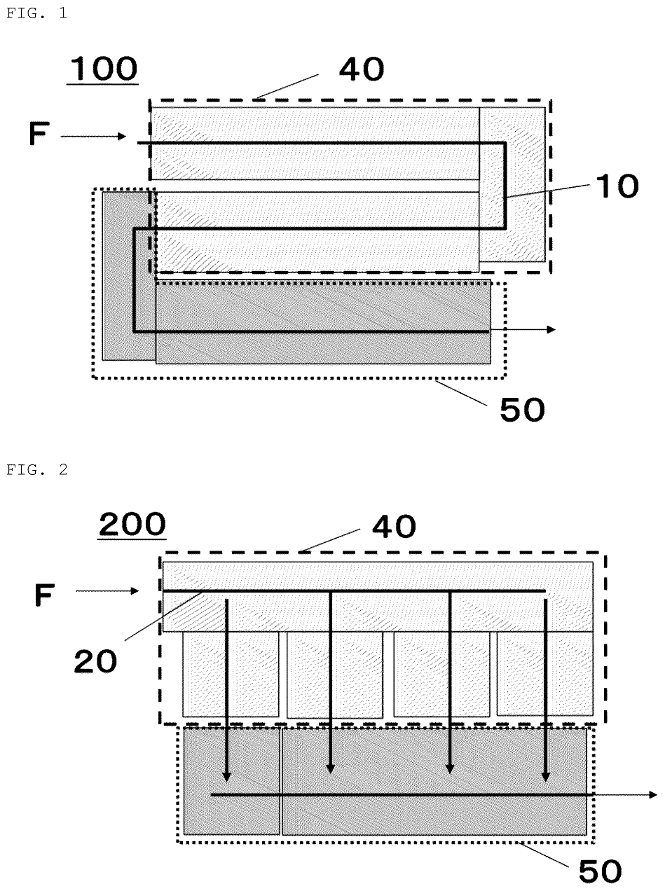

FIG. 1 is a schematic view showing an example of the cathode separator of the fuel cell of the present disclosure when viewed in plan.

The cathode separator 100 of the fuel cell of FIG. 1 has one oxidant gas flow path 10.

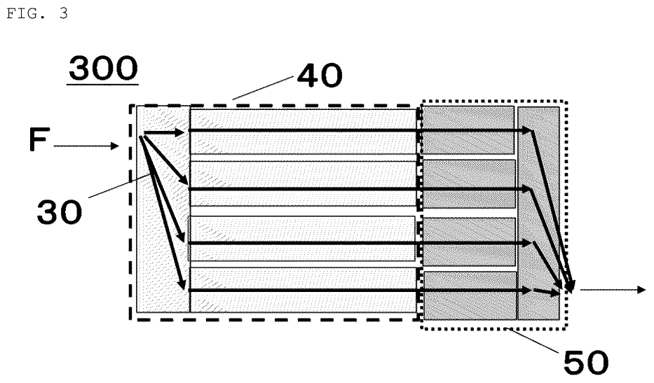

FIG. 2 is a schematic view showing another example of the cathode separator of the fuel cell of the present disclosure when viewed in plan.

The cathode separator 200 of the fuel cell of FIG. 2 has one oxidant gas flow path 20.

The one oxide gas flow path 20 branches into a plurality of flow paths on the upstream side 40 in the oxidant gas flow direction, and the plurality of flow paths branched on the downstream side 50 in the oxidant gas flow direction merge.

FIG. 3 is a schematic view showing another example of the cathode separator of the fuel cell of the present disclosure when viewed in plan.

The cathode separator 300 of the fuel cell of FIG. 3 has a plurality of oxidant gas channels 30.

In FIGS. 1 to 3, when the supply amount of the oxidizing gas F is optimized in consideration of fuel efficiency, the concentration overvoltage increases in a range of approximately 30% on the downstream side of the oxidizing gas flow path. Therefore, the surface pressure in the region 70% from the oxygen-containing gas inlet side of the oxygen-containing gas flow path which is the upstream side 40 in the flow direction of the oxygen-containing gas is higher than the surface pressure in the region 30% from the oxygen-containing gas outlet side of the oxygen-containing gas flow path which is the downstream side 50 in the flow direction of the oxygen-containing gas. However, the optimum value of the surface pressure distribution design changes because the concentration overvoltage is dominated by the supply amount of the oxidizing gas F, the specification of the oxidizing gas flow path, and the ease of supply of the oxidizing gas F to the power generation unit according to the specification of GDL. Therefore, the surface pressure distribution may be designed in accordance with these conditions.

### REFERENCE SIGNS LIST

10 Oxidant gas flow path
20 Oxidant gas flow path
30 Oxidant gas flow path
40 Upstream side in the oxidant gas flow direction
50 Downstream side in the oxidant gas flow direction
100 Cathode separator
200 Cathode separator
300 Cathode separator
F Oxidant gas

1. A fuel cell,
wherein the fuel cell comprises at least a power generation unit and a pair of separators sandwiching the power generation unit;
wherein each of the pair of separators has a groove constituting a flow path;
wherein the power generation unit comprises a gas diffusion layer; and
wherein, in a region of the power generation unit, a surface pressure on an upstream side of an oxidant gas flow direction is larger than a surface pressure on a downstream side of the oxidant gas flow direction.

2. The fuel cell according to claim 1,
wherein in a condition in which the gas diffusion layer is not pressurized, a thickness of the gas diffusion layer on the upstream side of the oxidant gas flow direction is larger than a thickness of the gas diffusion layer on the downstream side of the oxidant gas flow direction.

3. The fuel cell according to claim 1,
wherein a density of the gas diffusion layer on the upstream side of the oxidant gas flow direction is larger than a density of the gas diffusion layer on the downstream side of the oxidant gas flow direction.

4. The fuel cell according to claim 1,
wherein a depth of the groove on the upstream side of the oxidant gas flow direction is larger than a depth of the groove on the downstream side of the oxidant gas flow direction.

5. The fuel cell according to claim 1,
wherein one of the pair of separators is a cathode separator, and the other is an anode separator;
wherein the cathode separator has the groove constituting the oxidant gas flow path; and
wherein, when an entire region of the oxidant gas flow path is regarded as 100%, the upstream side of the oxidant gas flow direction is a region which is 30% to 70% of the entire region on the oxidant gas inlet side of the oxidant gas flow path.
